(19) United States
(12) Patent Application Publication
(10) Pub. No.: US 2005/0044143 A1
(43) Pub. Date: Feb. 24, 2005

(54) Instant messenger presence and identity management

(75) Inventors: Remy Zimmermann, Belmont, CA (US); Aaron Standridge, Fremont, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Logitech Europe S.A., Romanel-sur-Morges (CH)

(21) Appl. No.: 10/644,270

(22) Filed: Aug. 19, 2003

(51) Int. Cl. G06F 15/16

(52) U.S. Cl. 709/204

(57) ABSTRACT

The present invention provides a method and system for reliable and accurate presence/status management and identity detection in Instant Messaging (IM) applications by using video, still image, and/or audio information. In one embodiment, a device such as a camera captures still image, video, and/or audio data. Relevant information is then extracted from the captured data and analyzed. Known techniques such as face recognition, face tracking, and motion detection, can be sued for extracting and analyzing data. This information is then interpreted for the IM application, and provided to an Application Programs Interface (API) for the IM application. The API can use the information for various purposes, including updating the status of the user (e.g., available, busy, on the phone, away from desk, etc.) and updating the identity of the user.

### CROSS-REFERENCES TO RELATED APPLICATIONS NOT APPLICABLE

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK

Not Applicable

### FIELD OF THE INVENTION

The present invention relates generally to instant messenger services, and more specifically to user presence and user identity management for instant messenger services.

### BACKGROUND OF THE INVENTION

Over the past few years, contact established by people with each other over the Internet has increased tremendously. In particular, Instant Messaging (IM), which permits people to communicate with each other over the Internet in real time, has become increasingly popular. More recently, Instant Messaging also permits users to communicate not only using text alone, but also using audio, still pictures, video, etc.

Several IM programs are currently available, such as ICQ from ICQ, Inc., America OnLine Instant Messenger (AIM) from America Online, Inc. (Dulles, Va.), MSN® Messenger from Microsoft Corporation (Redmond, Wash.), and Yahoo!® Instant Messenger from Yahoo! Inc. (Sunnyvale, Calif.).

While these IM services have varied user interfaces, most of them work in the same basic manner. Each user chooses a unique user ID (the uniqueness of which is checked by the IM service), as well as a password. The user can then log on from any machine (on which the corresponding IM program is downloaded) by using his/her user ID and password. The user can also specify a “buddy list” which includes the userids and/or names of the various other IM users with whom the user wishes to communicate.

These instant messenger services work by loading a client program on a user's computer. When the user logs on, the client program calls the IM server over the Internet and lets it know that the user is online. The client program sends connection information to the server, in particular the Internet Protocol (IP) address and port and the names of the user's buddies. The server then sends connection information back to the client program for those of those buddies who are currently online. In some situations, the user can then click on any of these buddies and send a peer-to-peer message without going through the IM server. In other cases, messages may be reflected over a server. In still other cases, the IM communication is a combination of peer-to-peer communications and those reflected over a server. Each IM service has its own proprietary protocol, which is different from the Internet HTTP (HyperText Transport Protocol).

Once a user is logged in, most IM applications also indicate several different statuses for the user, such as “Available”, “Be right back”, “Busy”, “Idle”, “On the phone”, etc. In addition to these predefined statuses, most IM applications also allow the user to specify customized statuses. For example, a user could choose to include a status stating that he has “Gone Fishing.” These predefined and customized statuses provide the user's buddies with an indication of the user's availability.

Currently, IM applications base these various statuses on one of the following things. First, the user himself can change the status to indicate his situation. Second, the IM application can try to infer the user's status based on some timeout parameter. For instance, if the user's computer goes into power saver mode, the IM application may deduce that the user's status is “Idle” or “Away from Desk”, and automatically change the user's status accordingly. A similar inference may be made by the IM application if no keystrokes on the computer keyboard are detected for a pre-specified amount of time. However, such “user activity based timeout parameters” are not very reliable. For instance, a user could be at his desk doing some paperwork, and thus not use the computer's keyboard for a while. The IM application may interpret this status of the user inaccurately as “Idle” or as “Away from Desk”, both of which are inaccurate.

Further, the identity of the user using the computer cannot be determined by the IM application. For instance, a situation can arise where the user who is logged in to the IM application steps away from the computer for some time, and some other user uses the computer instead. Currently, the IM applications rely on the users to change their online identity. In the situation described, the first user would need to be actively logged out, and the second user would actively need to log in. Actively changing the user identity requires an extra effort on the part of the users. Further, users often neglect to perform such identity changes, thus resulting in an incorrect presentation of the status and/or identity of the users. One example of such a situation is a personal computer which is shared by a husband and a wife. In one scenario, the husband may be logged on into an IM application. He may step away, forgetting to log out. The wife may then start using the computer and neglect to log her husband out and to log herself in. The husband's status may thus be incorrectly displayed as “Available” to his IM buddies. In contrast, the wife's IM buddies will perceive that the wife is unavailable for an IM conversation because she is not logged in.

Thus there exists a need for a system and method which can identify the user of an IM application. In addition, there exists a need for a system and method which can intelligently update the status of a user of an IM application.

### BRIEF SUMMARY OF THE INVENTION

The present invention provides a method, and corresponding apparatus, for more reliable and accurate presence/status management and identity detection in IM applications by using sensory information captured by a device. Such information can include video, still image, and/or audio information.

In one embodiment, a device such as a camera captures still image, video, and/or audio data. Relevant information is then extracted from the captured data and analyzed. For instance, the extracted and analyzed information can relate to whether the user is visible, which user is visible, whether the user is on the phone, whether the user is working with papers, etc. Various techniques known in the art can be used for extracting and analyzing the captured information. Examples of such techniques include face tracking techniques, face recognition techniques, motion detection techniques, and so on.

The extracted and analyzed information is then interpreted to obtain information of relevance to an IM application. For instance, in one embodiment, if the user is visible as per the extracted and analyzed information, then the interpretation for the IM application is that the status of the user should be changed to “Available.” In one embodiment, if the user is not visible as per the extracted and analyzed information, then the interpretation for the IM application is that the status of the user should be changed to “Away from Desk”.

In one embodiment, the IM Application Program Interface (API) is then provided with this interpreted information. This results in the updating of the status of the user, and/or changing the identity of the user in the IM application.

The features and advantages described in this summary and the following detailed description are not all-inclusive, and particularly, many additional features and advantages will be apparent to one of ordinary skill in the art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE DRAWINGS

The invention has other advantages and features which will be more readily apparent from the following detailed description of the invention and the appended claims, when taken in conjunction with the accompanying drawing, in which:

FIG. 1 is a block diagram of one embodiment of a conventional IM system.

FIG. 2 is a block diagram of a system in accordance with an embodiment of the present invention

FIG. 3 FIG. 3 is a screen shot of a buddy list with various statuses displayed in one IM application.

FIG. 4 is a flowchart of the functioning of a system 200 in accordance with an embodiment of the present invention.

### DETAILED DESCRIPTION OF THE INVENTION

The figures (or drawings) depict a preferred embodiment of the present invention for purposes of illustration only. It is noted that similar or like reference numbers in the figures may indicate similar or like functionality. One of skill in the art will readily recognize from the following discussion that alternative embodiments of the structures and methods disclosed herein may be employed without departing from the principles of the invention(s) herein. It is to be noted that the present invention relates to any type of sensory data that can be captured by a device, such as, but not limited to, still image, video, or audio data. For purposes of discussion, most of the discussion in the application focuses on still image, video and/or audio data. However, it is to be noted that other data, such as data related to smell, could also be used. For convenience, in some places “image” or other similar terms may be used in this application. Where applicable, these are to be construed as including any such data capturable by a digital camera.

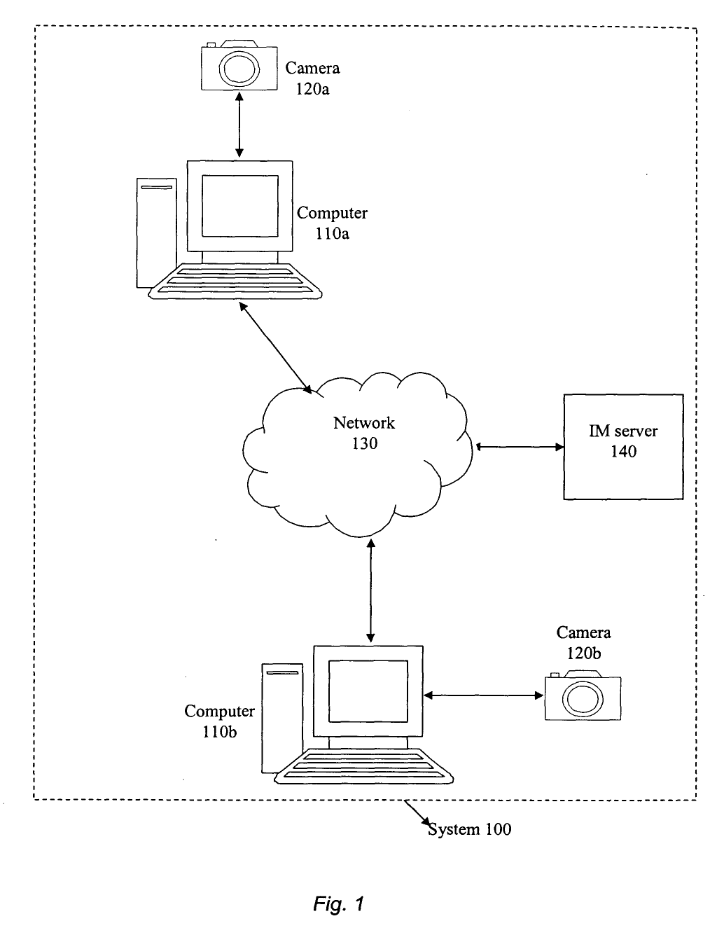

FIG. 1 is a block diagram of one embodiment of a conventional IM system 100. System 100 comprises computer systems 110a and 110b, cameras 120a and 120b, network 130, and an IM server 140.

The computer systems 110a and 110b are conventional computer systems, that may each include a computer, a storage device, a network services connection, and conventional input/output devices such as, a display, a mouse, a printer, and/or a keyboard, that may couple to a computer system. The computer also includes a conventional operating system, an input/output device, and network services software. In addition, the computer includes IM software for communicating with the IM server 140. The network service connection includes those hardware and software components that allow for connecting to a conventional network service. For example, the network service connection may include a connection to a telecommunications line (e.g., a dial-up, digital subscriber line (“DSL”), a T1, or a T3 communication line). The host computer, the storage device, and the network services connection, may be available from, for example, IBM Corporation (Armonk, N.Y.), Sun Microsystems, Inc. (Palo Alto, Calif.), or Hewlett-Packard, Inc. (Palo Alto, Calif.).

Cameras 120a and 120b are connected to the computer systems 110a and 110b respectively. Cameras 120a and 120b can be any cameras connectable to computer systems 110a and 110b. For instance, cameras 120a and 120b can be webcams, digital still cameras, etc.). In one embodiment, cameras 120a and/or 120b are QuickCam® from Logitech, Inc. (Fremont, Calif.).

The network 130 can be any network, such as a Wide Area Network (WAN) or a Local Area Network (LAN), or any other network. A WAN may include the Internet, the Internet 2, and the like. A LAN may include an Intranet, which may be a network based on, for example, TCP/IP belonging to an organization accessible only by the organization's members, employees, or others with authorization. A LAN may also be a network such as, for example, Netware™ from Novell Corporation (Provo, UT) or Windows NT from Microsoft Corporation (Redmond, Wash.). The network 120 may also include commercially available subscription-based services such as, for example, AOL from America Online, Inc. (Dulles, VA) or MSN from Microsoft Corporation (Redmond, Wash.).

The IM server 140 can host any of the available IM services. Some examples of the currently available IM programs are America OnLine Instant Messenger (AIM) from America Online, Inc. (Dulles, VA), MSN® Messenger from Microsoft Corporation (Redmond, Wash.), and Yahoo!® Instant Messenger from Yahoo!® Inc. (Sunnyvale, Calif.).

It can be seen from FIG. 1 that cameras 120a and 120b provide still image, video and/or audio information to the system 100. Such multi-media information will be harnessed by the present invention for purposes of presence/status management and/or identity detection.

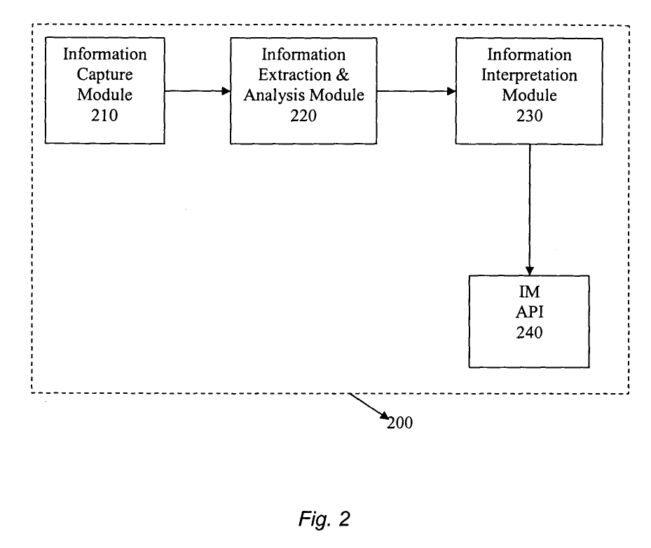

FIG. 2 is a block diagram of a system 200 in accordance with an embodiment of the present invention. System 200 comprises an information capture module 210, an information extraction and analysis module 220, an information interpretation module 230, and an IM Application Program Interface (API) 240.

In one embodiment, the information capture module 210 captures audio, video and/or still image information in the vicinity of the machine on which the user uses the IM application. Such a machine can include, amongst other things, a Personal Computer (PC), a cell-phone, a Personal Digital Assistant (PDA), etc. In one embodiment, the information capture module 210 includes the conventional components of a digital camera, which relate to the capture and storage of multi-media data. In one embodiment, the components of the camera module include a lens, an image sensor, an image processor, and internal and/or external memory.

The information extraction and analysis module 220 serves to extract information from the captured multi-media information. Such information extraction and analysis can be implemented in software, hardware, firmware, etc. Any number of known techniques can be used for information extraction and analysis. For example, motion detection techniques (e.g., software such as Digital Radar® from Logitech, Inc. (Fremont, Calif.)) or face tracking techniques can be used for detecting whether a user is present in the vicinity of the machine on which the IM application is running. As another example, face recognition techniques can be used to identify which user is in the vicinity of the machine on which the IM application is running. In one embodiment, the information extraction and analysis module will extract relevant information (e.g., edge information, bitmaps, etc.), and compare this extracted information to previously stored information (e.g., in a database). For instance, in one embodiment, edge information techniques are used to extract information from a captured image. This edge information is then compared to edge information previously stored in a database. The information previously stored on the database can include edge information on what a human face looks like, what a human face adjacent to a phone looks like, etc.

In one embodiment, the output of the information extraction and analysis module is independent of the API 240 to which the information is eventually supplied. For instance, the output of the information extraction and analysis module may simply indicate that “a human face is present” or “motion is detected”. The information interpretation module 230 then takes this output and interprets it, based on the API 240 to which the information is to be provided. For instance, the outputs “a human face is present” or “motion is detected” may be interpreted, for an IM application, as “status of user should be ‘available’”. It is to be noted that this interpretation module 230 can be implemented in software, hardware, firmware, etc., or in any combination of these.

The interpreted information is then provided to the API 240 for the IM application. The IM API 240 can then use this interpreted information for various purposes. For example, the information interpreted as “status of the user should be ‘available’”, when provided to the IM API, will result in the status being updated to “Available.” Amongst other things, the IM API 240 can be provided with information relating to presence/status management, and user identification. Each of these is discussed in detail below.

Presence/Status Management:

Once the user logs into an IM service, most IM applications include indicators of user status. The user's buddies can see such a status next to the user's name/nickname/userid. These statuses include both predefined status such as “Available”, “Be right back”, “Busy”, “Idle”, “On the phone” etc., as well as customized statuses that the user may have defined.

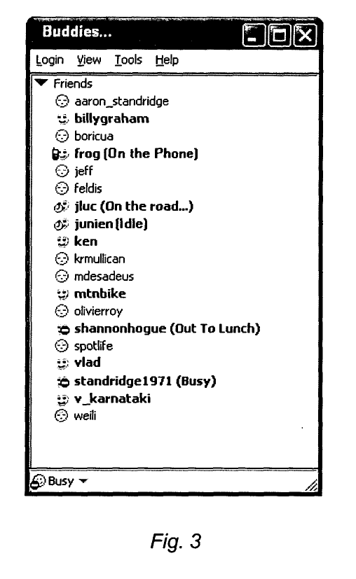

FIG. 3 is a screen shot of a buddy list with various statuses displayed in one IM application. As can be seen from FIG. 3, in some IM applications, when a user is logged in, his buddies see his name/nickname/userid in bold. In some IM applications, the default status when a user is logged in is that he is available. Thus a bolded username without a status following it indicates that the user's status is “Available”. Several different user statuses (e.g., on the phone, busy, idle, out to lunch, etc.) can be seen in FIG. 3.

In accordance with an embodiment of the present invention, audio, video, and/or still image information is used to intelligently update these statuses. Such information is captured in the vicinity of the machine on which the user is using the IM application, is captured. For example, a user uses an IM application on his personal computer, and an attached webcam serves to capture the information. The captured audio, video and/or still image information can be analyzed to determine the status of the user. For example, an image of the user with a phone instrument next to his head indicates that the user is “On the phone”. As another example, an image of the user looking down at the desk (e.g., writing or reading) is interpreted as “Busy”. It will be obvious to one of skill in the art that the specific information analyzed, the particular statuses associated with different information, etc. can vary significantly.

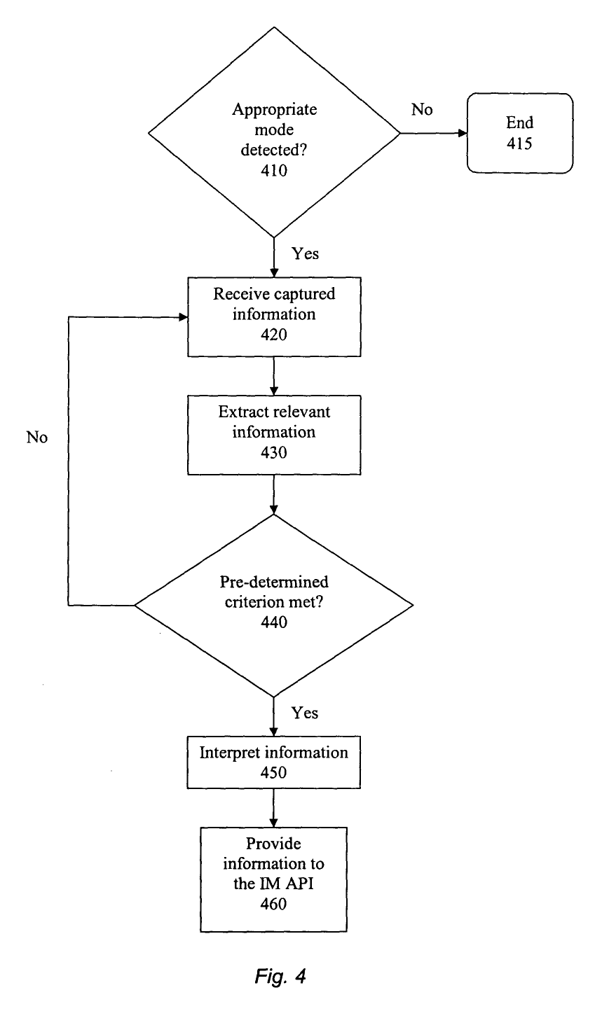

FIG. 4 is a flowchart of the functioning of a system 200 in accordance with an embodiment of the present invention.

In one embodiment, as can be seen from FIG. 4, system 200 has to determine (step 410) whether or not the system 200 is in the appropriate mode. If the system 200 is not in the presence/status management mode, no further action is taken (step 415). If the system is in the presence/status management mode, then certain steps described below are implemented. There are several ways in which the system 200 could enter the presence/status management mode. In one embodiment, the system 200 is in the presence/status management mode at any time when a user is logged into an IM application. In another embodiment, the user may explicitly have to start the presence/status management mode. E.g., the user presses a specific physical button, or makes certain selections on a computer or on the camera itself, provide a voice command, etc. In still another embodiment, the presence/status management mode is triggered by the user performing a certain gesture, which is recognized by the system as starting the presence/status management mode. In yet another embodiment, predefined events can trigger the start of the presence/status management mode. Such trigger events can include, for example, recognition of the face of a specific user, a user's approaching of the camera in a certain manner, etc.

When the system is in the presence/status management mode, it continually receives (step 420) still image, video and/or audio data. Relevant information is then extracted (step 430) from this received data. As mentioned above with respect to FIG. 2, various techniques can be used to extract information. For example, face recognition techniques can be used on the received image data to determine whether a human head is visible.

The extracted information is analyzed (step 440). In one embodiment, the analysis comprises checking to see whether the extracted information meets some pre-determined criterion. If the pre-determined criterion is not met, the next received information is extracted. If the pre-determined criterion is met, the steps described below are performed.

In one embodiment, the criterion is to compare the extracted information (e.g., edge information) to some previously stored information, and see if a match is found. An example of such previously stored information is provided in Table 1.

TABLE 1

| Information | Map to output |
|---|---|
| Information regarding the shape of a | User is present |
| human head | |
| Information regarding the shape of a | User is on the phone |
| human head next to the shape of a phone | |
| Information regarding the shape of a | User is reading |
| human head looking down at the desk | |
| Discussion (audio information) | User is in a meeting |

In one embodiment, audio information is combined with still image or video information to map to a certain output. For instance, in one embodiment, image information regarding the shape of a human head next to the shape of a phone is combined with audio information relating to a user talking on the phone (e.g., detection of user saying “hello”) to determine that the user is on the phone. In another embodiment, a computer on which the user is using the IM application can electronically monitor the phone line it is attached to monitor the user's “on the phone” status. In one embodiment, the machine (e.g., computer) is able to differentiate between sound created by itself (e.g., music), and sound created by the user, for purposes of updating status based on audio input.

If information matching the extracted information is found in the previously stored information, it is mapped to the appropriate output. If information matching the extracted information is not found in the previously stored information, the next information received is extracted (step 430).

In another example, received video data is subjected to motion detection techniques. Software such as Digital Radar® by Logitech, Inc. (Fremont, Calif.) can be used for motion detection. In one embodiment, successive video frames are compared to assess the change in pixel values of specific areas. If this change is more than a certain pre-specified threshold, it is assumed that motion is detected. This pre-specified threshold can be part of previously stored information accessible to the information extraction and analysis module 220. An example of such information is provided in Table 2.

TABLE 2

| Information | Map to output |
|---|---|
| Change in pixel value equal to or greater | User is present |
| than pre-specified threshold | |
| Change in pixel value less than | User is absent |
| pre-specified threshold | |

Once again, information is mapped to the appropriate output based on Table 2. In one embodiment, motion detection techniques can be combined with other techniques (e.g., heat sensing) to obtain more accurate results. For instance, in one embodiment, combining motion detection techniques with sensing heat generated from a user's body ensures that moving objects (e.g., blowing papers etc.) do not get confused with a user.

The extracted and analyzed information is then interpreted (step 450) based on the application to which the information is to be provided. For example, if the extracted and analyzed information is to be provided to an IM application, the output of the information extraction and analysis module 220 is mapped to certain IM statuses. An example of this is provided in Table 3.

TABLE 3

| Output of Information Extraction | |
|---|---|
| & Analysis Module | Map to IM status |
| User present | Available |
| User absent | Away from desk |
| User is on the phone | On the phone |
| User is reading | Busy |

This IM status is then provided (step 460) to the IM API 240, which in turn updates the user's status appropriately.

In one embodiment, the extracted and analyzed information is independent of the application to which the information is to be ultimately provided. In other words, the extracted and analyzed information can be used for various different purposes. The interpretation (step 450) of the data is dependent on the application to which the information is to be provided (step 460).

It is to be noted that the status of a user may be indicated not only in users' buddy lists, but also (or instead) in other appropriate locations, such as within an open chat window. As an example, consider an instance where a first user is interrupted by a phone call while involved in an IM chat with a second user. Instead of the second user wondering why it is taking the first user so long to respond, the active chat window indicates, in one embodiment, that the first user is “on the phone.”

In one embodiment, an “uncertain availability” status can be displayed if the system is uncertain of which status to assign to the user. In another embodiment, statuses assigned by a system in accordance with the present invention are distinguished in some way from statuses selected by the user himself. For instance, different formats (such as bold, italics, etc.), different colors, etc., are used in one embodiment to distinguish between a status set by the user, and a status automatically detected by the computer.

Identification of Users:

Apart from the presence/status management application of the present invention described above, another application of the present invention is for intelligent identification of users of IM applications.

Several users sometimes use the same machine. In such situations, it is possible that a previous user mistakenly remains logged on, while a different user may actually by present near the machine instead.

In accordance with an embodiment of the present invention, still image, video and/or audio information can be used to intelligently identify the user in the vicinity of the machine, and to intelligently log in and log out the appropriate users of the IM application.

The functioning of a system in accordance with an embodiment of the present invention can also be understood by referring to FIG. 4. As described above, it is determined (step 410) whether the system is in the appropriate mode. If it is not, no further action is taken (step 415).

If the system is in the user identification mode, then captured video, still image and/or audio data is received (step 420).

The received information is then extracted (step 430). The specific information extraction techniques used may vary, based on several factors. One such factor is the number of users who share a given computer. When this number is small (e.g., in the situation where different members of a family are sharing a personal computer), relatively simple techniques may be used to identify the various users. When this number is large, however (e.g., a workplace computer shared by a working group), more complex techniques may need to be employed.

In one embodiment, face recognition techniques known in the art can be used to identify the user. The extracted information is then checked (step 440) to see if a pre-defined criterion is met by the extracted information. If not, captured information is received (step 420). If yes, further steps are taken. In one embodiment, the potential users of IM on a specific machine (e.g., personal computer) are known in advance. A database containing extracted information for images of the face each of these potential users can be stored, and the pre-determined criterion is whether there is a match for the extracted information in the database.

The extracted and analyzed information is then interpreted (step 450). For instance, in one embodiment, interpretation comprises a mapping from the identified user to the user's userid/login name for the IM application. The interpreted information is provided (step 460) to the IM application. In the described embodiment, the IM application then logs in the user with the specified userid, and logs out any other users who may have been logged in to the IM application.

As will be understood by those of skill in the art, the present invention may be embodied in other specific forms without departing from the essential characteristics thereof. For example, audio information alone may be used instead of video and still image information for presence and/or identity management. For instance, when a user's voice is heard, the status of the user may be changed to “On the phone” or “In a meeting.” As another example, users may be able to define how/when to change the status indicator and/or the user identification, the trigger events that would initiate the presence and identity management modes, etc. As still another example, users may be able to specify different statuses depending on which application on the computer they are using. (For instance, in one embodiment, a user is able to customize that his status will be indicated as being “busy” if he is working in Microsoft® Excel™ or Microsoft® Word™, but as “available” if he is using an email application or is browsing the Internet.) As yet another example, other information, such as information relating to smell, movement (e.g., walking, running), location (e.g., information provided by a Global Positioning System), fingerprint information, other biometric information, etc. may be used as inputs to a system in accordance with the present invention. While particular embodiments and applications of the present invention have been illustrated and described, it is to be understood that the invention is not limited to the precise construction and components disclosed herein and that various modifications, changes, and variations which will be apparent to those skilled in the art may be made in the arrangement, operation and details of the method and apparatus of the present invention disclosed herein, without departing from the spirit and scope of the invention, which is defined in the following claims.

1. A system for updating an Instant Messaging (IM) application regarding a user of the IM application, wherein the updating is based on multimedia information, the system comprising:
an information capture module for capturing the multimedia information in the vicinity of a machine on which the user is using the IM application;
an information extraction and analysis module communicatively coupled with the information capture module, for extracting relevant information from the captured multimedia information; and
an information interpretation module communicatively coupled with the information extraction and analysis module, for interpreting the
extracted and analyzed information for the IM application, wherein the interpreted information can be used for updating the IM application.

2. The system of claim 1, wherein the multimedia information comprises at least one of audio information, still image information, and video information.

3. The system of claim 1, further comprising:
an Application Program Interface module for the IM application, communicatively coupled to the information interpretation module, for receiving the interpreted information and updating the IM application regarding the user.

4. The system of claim 3, wherein the Application Program Interface module is configured to update the user's status on the IM application.

5. The system of claim 4, wherein the user's status comprises at least one of available, busy, on the phone, and away from the desk.

6. The system of claim 3, wherein the Application Program Interface module is configured to update the user's identity on the IM application.

7. The system of claim 6, wherein updating the user's identity on the IM application comprises logging out a previous user, and logging in the user on the IM application.

8. The system of claim 1, wherein the information extraction and analysis module employs face tracking techniques.

9. The system of claim 1, wherein the information extraction and analysis module employs motion detection techniques.

10. The system of claim 1, wherein the information extraction and analysis module employs face recognition techniques.

11. A method for updating an IM application regarding a user based on captured multimedia information, the method comprising:
receiving the captured multimedia information;
extracting and analyzing relevant information from the captured multimedia information;
interpreting the analyzed information for the IM application;
providing the interpreted information to the IM application; and
updating the IM application based on the provided information.

12. The method of claim 11, wherein the updating step comprises:
updating the status of a user of the IM application.

13. The method of claim 12, wherein the extracting and analyzing step comprises tracking a face.

14. The method of claim 12, wherein the extracting and analyzing step comprises detecting motion.

15. The method of claim 11, wherein the updating step comprises:
updating the identity of the user of the IM application.

16. The method of claim 15, wherein the extracting and analyzing step comprises recognizing a face.
